(19) United States
(12) Patent Application Publication
(10) Pub. No.: US 2008/0320267 A1
(43) Pub. Date: Dec. 25, 2008

(54) Memory Element, Data Processing System, Method for Setting Operating Parameters of a Memory and Computer Program

(76) Inventors: Christoph Bilger, Munich (DE); Markus Balb, Unterhaching (DE)

Correspondence Address: SLATER & MATSIL, L.L.P., 17950 PRESTON ROAD, SUITE 1000, DALLAS, TX, 75252, US

(21) Appl. No.: 12/143,474

(22) Filed: Jun. 20, 2008

(30) Foreign Application Priority Data
Jun. 22, 2007 (DE) 10 2007 028 870.2

(51) Int. Cl. G06F 12/00; G06F 1/08

(52) U.S. Cl. 711/170; 713/600; 711/E12.001

(57) ABSTRACT

A memory element includes a memory which is operable according to operating parameters from at least two sets of operating parameter values and an operating parameter control which is implemented to receive operating state information and to select a set of operating parameter values for the operation of the memory based on the operating state information.

This application claims priority to German Patent Application 10 2007 028 870.2, which was filed Jun. 22, 2007 and is incorporated herein by reference.

### TECHNICAL FIELD

The invention relates to a memory element, e.g., a memory element which may be used in a data processing system.

Embodiments of the invention relate to a memory element having a memory which is operable according to operating parameters from at least two sets of operating parameter values. The memory element includes an operating parameter control which is implemented to receive operating state information and to select a set of operating parameter values for the operation of the memory based on the operating state information.

Further embodiments of the invention relate to a data processing system having a memory element.

Again further embodiments of the invention relate to a method for setting operating parameters of a memory and a computer program.

### BRIEF DESCRIPTION OF THE DRAWINGS

FIG. 1 shows a block diagram of a memory element according to one embodiment of the invention;

FIG. 2 shows a block diagram of a memory element according to a further embodiment of the invention;

FIG. 3 shows a block diagram of a memory element according to a further embodiment of the invention;

FIG. 4 shows a block diagram of a data processing system according to one embodiment of the invention;

FIG. 5 shows a flowchart of a method according to one embodiment of the invention;

FIG. 6 shows a schematical illustration of a data processing system according to one embodiment of the invention; and

FIG. 7 shows a tabular illustration of operating parameter values in different operating states according to one embodiment of the invention.

### DETAILED DESCRIPTION OF ILLUSTRATIVE EMBODIMENTS

Conventional data processing systems, for example, computer systems, usually include a processor (for example, a central processor or a task-specific processor, like, for example, a graphics processor), which cooperates with a memory. The memory may here include both data and also instructions or only one of the two. Most computing systems (and/or computer systems) which consist of a processor and a memory need their full capacity for only a very short part of their operating time. For the rest of the time, the system does not need the available power. In order to save power (in particular with portable applications) and to prevent overheating, these systems adapt different parameters, like, for example, a voltage and/or operating voltage and/or an operating frequency according to the load of the system.

For a controller-memory interface and for the operating conditions of the memory, all changes are initiated and implemented step by step by the controller. The controller will here change every parameter, one after the other. The memory behaves completely passively and reacts to the instructions of the controller.

This concept involves several problems:

the communication has to be individually developed for each memory type (depending on density and/or memory density, chip version (die revision) and memory provider);

the allowable parameter ranges are different between all memory types; and

some parameters may not conventionally be changed dynamically, for example, the memory operating voltage.

A high effort of development is needed to implement characteristics of elements in a system which may be described by parameters. In addition to that, it is virtually impossible, before a development, due to a plurality of different available memories or future memories, to estimate the effort to realize a system which is operable with a plurality of different types of memories.

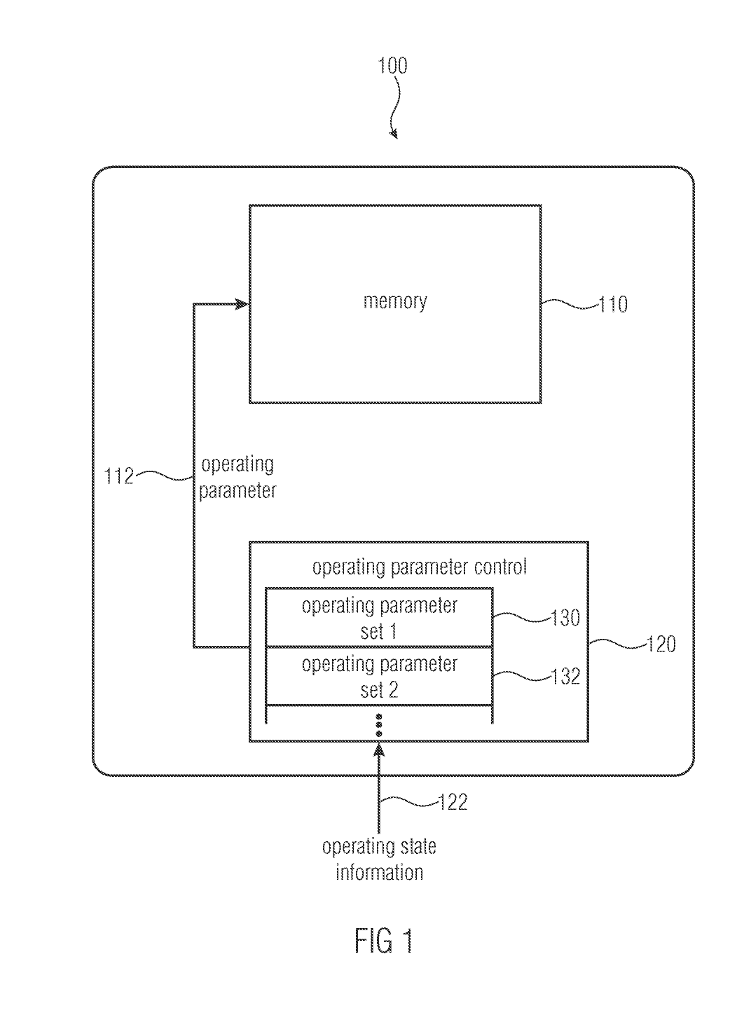

FIG. 1 shows a block diagram of a memory element (also designated as memory device or memory component) according to one embodiment of the invention. The memory element according to FIG. 1 is designated by 100 in its entirety. The memory element 100 includes a memory 110 which is, for example, implemented to store data and/or instructions for a processor. Operating parameters 112 act on the memory 100, wherein the memory 110 is implemented such that the memory 110 is operable according to operating parameters from at least two sets of operating parameters.

The memory element 100 further includes an operating parameter control 120. The operating parameter control 120 is implemented to receive operating state information 122. Further, the operating parameter control 120 is implemented to select a set of operating parameter values for the operation of the memory 110 based on the operating state information 122. Thus, the operating parameters 120 acting on the memory 110 are determined.

The operating parameter control 120, for example, includes information about at least two operating parameter sets 130, 132 which describe different combinations of operating parameters. In response to the operating state information 122, the operating parameter control 120, for example, selects a set from the operating parameter sets 130, 132 to thus obtain the operating parameters 112 for the memory 110.

The embodiment of the memory element 100 described in FIG. 1 is based on the finding that it is advantageous to provide information about different sets of operating parameter values in the memory element 100 and to select the same via operating state information 122. In other words, according to the embodiment of FIG. 1, the operating parameters do not have to be externally provided to the memory element, but the operating parameter control 120 which is part of the memory element 100 is itself able to determine the operating parameters. For this purpose, the operating parameter control 120 only receives operating state information 122. The operating state information 122 may here, for example, indicate that the memory element 110 is to be operated in a standby state or in a high-performance (fast) state. In response to the abstract operating state information 122 which only describes a desired operating state, in one embodiment of the invention the operating parameter control 120 determines a corresponding set of operating parameter values for the operation of the memory. Thus, in the operating parameter control 120 a mapping of the abstracted operating state information to concrete operating parameter values takes place.

It is not obligatory for a memory controller which controls the memory element 110 to have complete knowledge about operating parameters usable by the memory 110 and/or about the allowable operating parameter values. It is, rather, sufficient if the memory controller knows which states of operation (for example, standby, slow operation, fast operation) the memory element 100 may take. Thus, a control of different memory elements 100 with different allowable operating parameter values which are, for example, all present in a common system may take place in a similar way. For this purpose, the controller, for example, only outputs operating state information to any of the individual memory elements 100 which may, for example, indicate that the memory elements 100 should pass into a standby operating state. The operating parameter controls of the individual memory elements in this case set the operating parameters of the associated memory to suitable operating parameter values independently, wherein the same may be different from memory element to memory element and are known to the respective operating parameter controls.

Thus, a memory controller and/or a processor which takes over the function of the memory controller is unburdened of the task to specifically set parameters for the operation of the individual memory components. It is, rather, sufficient for the controller and/or the processor to only qualitatively know the operating states provided by a memory element.

In other words, according to one embodiment of the invention, the operating parameter control 120 of a memory element 100 takes over setting the operating parameters 112 for the memory 110 based on the abstract operating state information. Thus, for one memory controller or one processor which cooperates with the memory element 100 an interface for the operating state information is available which enables a description of the operating states by means of value-discrete information (information on the selected state). Via the interface between the memory controller and the memory element 100, thus for the setting of the operating state no specific physical parameters have to be transmitted.

According to one embodiment of the invention, the inventive concept enables using a memory controller or processor unchanged with different types of memories which comprise different operating parameters for a certain state (for example, the standby state).

Thus, a system design is facilitated. Apart from that, system costs are decreased. In addition, each memory element may be operated with ideal operating parameters, without the cooperation of external components (for example, the memory controller or the processor) being needed. Technical improvements of the memory elements may thus be used to full capacity without having to change the corresponding circuit (for example, the memory controller and/or the processor).

Thus, one embodiment of the invention provides an improved concept for changing operating parameters of a memory element.

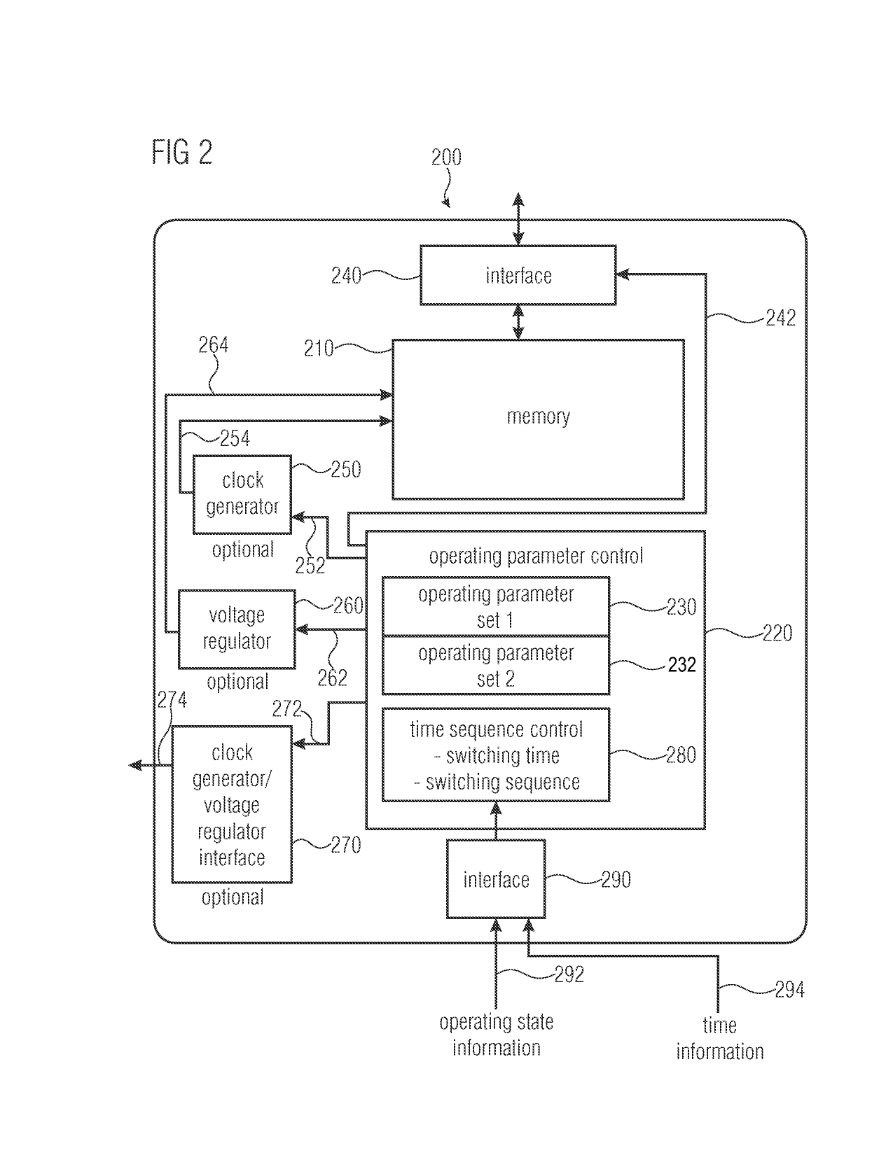

FIG. 2 shows a block diagram of a memory element according to a further embodiment of the invention. The memory element according to FIG. 2 is designated by 200 in its entirety. The memory element 200 includes a memory 210 which basically corresponds to the memory 110 of the memory element 100. The memory element 200 further includes an operating parameter control 220 which basically corresponds to the operating parameter control 120. The operating parameter control 220 includes information about at least two operating parameter sets 230, 232 which, for example, correspond to the operating parameter sets 130, 132.

In addition to the components described with reference to the memory element 100, the memory element 200 may include different additional components. The memory element 200, for example, includes (optionally) a memory interface 240 which is connected between the memory 210 and an external circuit of the memory element 200. The memory interface 240 thus has the task of acting as an interface between the memory 210 and the external circuit (in the form of a memory controller and/or a processor). Thus, in one embodiment of the invention, an address selection of the memory address of the memory 210 may take place using the memory interface 240. Further, an input and/or an output of memory information (for example, an output of stored information or an input of information to be stored) may take place using the memory interface 240. In this respect it is to be noted that the memory interface 240 is operated according to memory interface operating parameters 242 which are provided by the operating parameter control 220 to the memory interface 240. The operating parameter control 220 is implemented, in one embodiment of the invention, to select the memory interface operating parameters 242 depending on the operating state information by the operating parameter control selecting an operating parameter set 230, 232 which, among other things, also includes operating parameter values for the memory interface operating parameters 242.

Typical operating parameters of the memory interfaces are, for example, time sequence (time flow) parameters which describe time sequences of interface signals. Thus, for example, an interface clock frequency belongs to the memory interface operating parameters 242. Further, the memory interface operating parameters may, for example, further include level information on interface signals, using which, for example, (voltage) levels of interface signals may be set. Thus, for example, a voltage swing of the interface signals processed or provided by the memory interface may be set by the memory interface operating parameters. Further, using the memory interface operating parameters, for example, driver parameters of the memory interface 240 may be set, whereby, for example, rise times of signals may be changed. If, for example, a current which may be provided by the memory interface on individual information lines is set to a high value, steep signal edges may be generated which enable a fast information transmission. If the operating parameters of the memory interface 240 are in contrast to that set such that only comparatively low currents may be provided on individual signal lines, the resulting signal edges are less steep. A possible data transmission rate decreases, as does the power loss.

A further possible operating parameter of the memory interface 240, which may be influenced by the operating parameter control is, for example, a termination state. If a termination of signal lines is activated, signal reflections at terminated inputs of the memory element 200 are strongly reduced in contrast to a non-terminated state. Thus, the possibility results of being able to reliably realize an especially fast data transmission. However, by the termination typically the current consumption increases. If the termination is deactivated, however, greater signal reflections occur at the inputs of the memory element 200, which may lead to problems, at least with high data transmission rates. With comparatively low data transmission rates, however, the deactivation of the termination does not interfere, or only insignificantly, while, however, by the deactivation of the termination the current consumption is substantially decreased.

It is thus to be noted that in one embodiment the termination state of the memory interface 240 may be set by the operating parameter control 220 depending on the selected operating state, whereby, for example, the current consumption of the memory element 200 may be optimized.

Further, in one embodiment of the invention, the memory interface 240 may (optionally) include a delay-locked loop which is implemented to balance signal runtimes inside or outside the memory element 200 to thus achieve a best possible synchronization of different signals. The use of a delay-locked loop is, for example, advantageous in the operation of the memory 210 with especially high clock frequencies. The operation of a delay-locked loop may (among other things by the use of settable delay elements) necessitate a high power consumption. In one embodiment of the invention, the operating state of the delay-locked loop may be switched on and off by the operating parameter control 220. Thus, depending on the operating state information, using an associated operating parameter set, it may be determined by the operating parameter control 220 whether the delay-locked loops are switched on or off.

In a further embodiment, the memory element 200 (optionally) includes a clock generator 250. The clock generator 250 is, for example, implemented to receive a clock generator operating parameter 252 from the operating parameter control 220 and transmit a settable clock signal 254 to the memory 210 (or, alternatively or additionally, to the memory interface 240). In one embodiment, the clock generator 250 is implemented to set a frequency of the clock signal 254 depending on the clock generator operating parameter 252. For example, the clock generator 250 may be implemented to set the frequency of the clock signal 254 depending on the clock generator operating parameter 252 provided by the operating parameter control 220 to a high value or to a low value to thus influence a working speed of the memory 210. The clock generator 250 may, by the way, for example either be an oscillator having a settable oscillation frequency or a settable frequency divider which generates the clock signal 254 by dividing an original clock signal.

In a further embodiment, the memory element 200 (optionally) includes a voltage regulator 260 which is implemented to obtain a voltage regulator operating parameter 262 and provide the supply voltage 264 to the memory 210 depending on the voltage regulator operating parameter 262. In other words, the voltage regulator 260 is in one embodiment a settable voltage regulator which is part of the memory element 200 and which is implemented to supply a variable, operating state-dependent supply voltage 264 to the memory 210. Thus, the operating parameter control 220 is, for example, able to set the voltage regulator operating parameter 262 depending on the operating state described by the operating state information, so that a higher operating voltage is supplied to the memory 210, for example, in an operating state described by the first operating parameter set 230 than in an operating state described by the second operating parameter set 232.

In a further embodiment, the memory element 200 (optionally) includes a clock generator/voltage regulator interface 270, which is implemented to receive a clock generator operating parameter and/or a voltage regulator operating parameter 272 from the operating parameter control 220. The clock generator/voltage regulator interface 270 is further implemented to provide a clock generator control signal and/or a voltage regulator control signal 274 depending on the clock generator operating parameter and/or the voltage regulator operating parameter 272. The clock generator control signal and/or the voltage regulator control signal 274 is, for example, led out at an external interface of the memory element 200 to control an external clock generator and/or an external voltage regulator. Thus, for example by an external clock generator, a clock signal may be generated for the memory 210, wherein the clock frequency of the clock signal may be set and/or is set by the operating parameter control, depending on the operating state information using the operating parameter sets 230, 232.

In a similar way, by an external voltage regulator a supply voltage for the memory 210, controlled by the operating parameter control 220, may be provided depending on the operating state information.

In summary, it may thus be noted that the operating parameter control, in one embodiment of the invention, may set a clock frequency of the memory 210 and/or a supply voltage of the memory 210 either using an internal clock generator and/or voltage regulator or using an external clock generator and/or an external voltage regulator.

In a further embodiment of the invention, the operating parameter control 220 includes an (optional) time sequence control 280. The time sequence control 280 may, for example, be implemented to receive operating state information 292 (which may, for example, correspond to the operating state information 122) and further, optionally, time information 294 via an interface 290. The operating state information 292, for example, carries information about a current operating state or, if the state described by the operating state information 292 is different from the current operating state, about a future operating state. The time information 294, for example, carries information about when a new operating state is to be taken over. If, for example, new operating state information 292 is transmitted via the interface 290 to the memory element 200, which indicates that the memory element is to pass into a new operating state, then the associated time information 294 may, for example, indicate when the transition regarding the operating state is to take place. For example, the time information 294 may indicate a number of clock periods which are to pass between the transmission of new operating state information (changed compared to the current operating state) and the change of the operating parameters by the operating parameter control 220. Thus, the time sequence control in this embodiment is implemented to receive time information 294 and to determine a switching time at which the operating parameters are changed from the operating parameter values of the first operating parameter set 230 to the operating parameter values of the second operating parameter set 232 depending on the time information 294. If, thus, a memory controller (or a corresponding processor) transmits operating state information 292 to the memory element 200 which indicate a change of the operating state, and associated time information 294, the memory controller (or processor) may determine exactly, using the same, when the memory element 200 changes its operating state. It may be achieved by this that the memory controller may be synchronized with the change of the operating parameters of the memory element. In other words, the memory controller may, for example, instruct the memory element 200 to change the operating state exactly when also the memory controller is able to adapt to this change.

If, further, in a system, for example, several memory elements 200 exist which may change their operating states with a different speed, then the memory controller may, for example, determine exactly how fast the memory elements are to change their operating state. If the memory controller, for example, determines that a memory element is present in a system which can only change its operating state very slowly compared to other memory elements, the memory controller may, for example, instruct any memory elements by outputting suitable time information 294 to change the operating state only slowly (according to the speed of the slowest element). Thus, for example, also in the presence of different fast memory elements 200, the change of the operating states may be coordinated by the indication of suitable time information 294. If, however, for example only one fast memory element is present in a system, the memory controller may instruct this memory element by outputting suitable time information 294 to change its operating state as fast as possible.

In a further embodiment, the time sequence control 280 is further implemented, optionally, alternatively or additionally to the above-described functionality, to control a switching sequence. Thus, the time sequence control 280 may, for example, be implemented to first change a first operating parameter when changing from operating parameter values according to a first operating parameter set 230 to operating parameter values according to a second operating parameter set 232, and later change a second operating parameter.

If, for example, a change of an operating state takes place directly from a first operating state (state 1) to a second operating state (state 2) without passing through a further externally given operating state, for example, two (or more) operating parameters may change. For example, in the first operating state (state 1) a clock frequency may be 400 MHz, while, however, the clock frequency in the second operating state (state 2) is only 150 MHz. Further, for example, in the first operating state the supply voltage for the memory may be 1.8 V, while, however, the supply voltage for the memory in the second operating state is only 1.5 V. When converting from the first operating state into the second operating state (if the operating state information 292 first indicates the first operating state, and directly afterwards, without passing through a valid further state, indicates a second operating state), for example, by the time sequence control 280, first a change of the working frequency from 400 MHz to 150 MHz and subsequently a change of the operating voltage from 1.8 V to 1.5 V may be achieved. By the fact that, for example, first the working frequency and subsequently the operating voltage is changed, an instability may, for example, be prevented. With an operating voltage of 1.8 V, the memory is, for example, easily able to work both with operating frequencies of 400 MHz and also of 150 MHz. With an operating voltage of only 1.5 V, the memory is, for example, no longer able to process a frequency of 400 MHz. By the determination of a time sequence in the change of more than two operating parameters (for example, frequency and operating voltage), it may thus be guaranteed that the memory 210 works reliably at any point of time.

Thus, no separate measures have to be taken externally (i.e., for example, by an external memory controller) to facilitate the passage from the first operating state (400 MHz; 1.8 V) into the second operating state (150 MHz; 1.5 V). It is, rather, sufficient, from the first operating state, to pass operating state information 292 which indicates that a transmission into the second operating state is to take place. Optionally, time information 294 may be passed additionally from the external controller to the memory element 200 which indicates exactly when the change of the operating state is to take place.

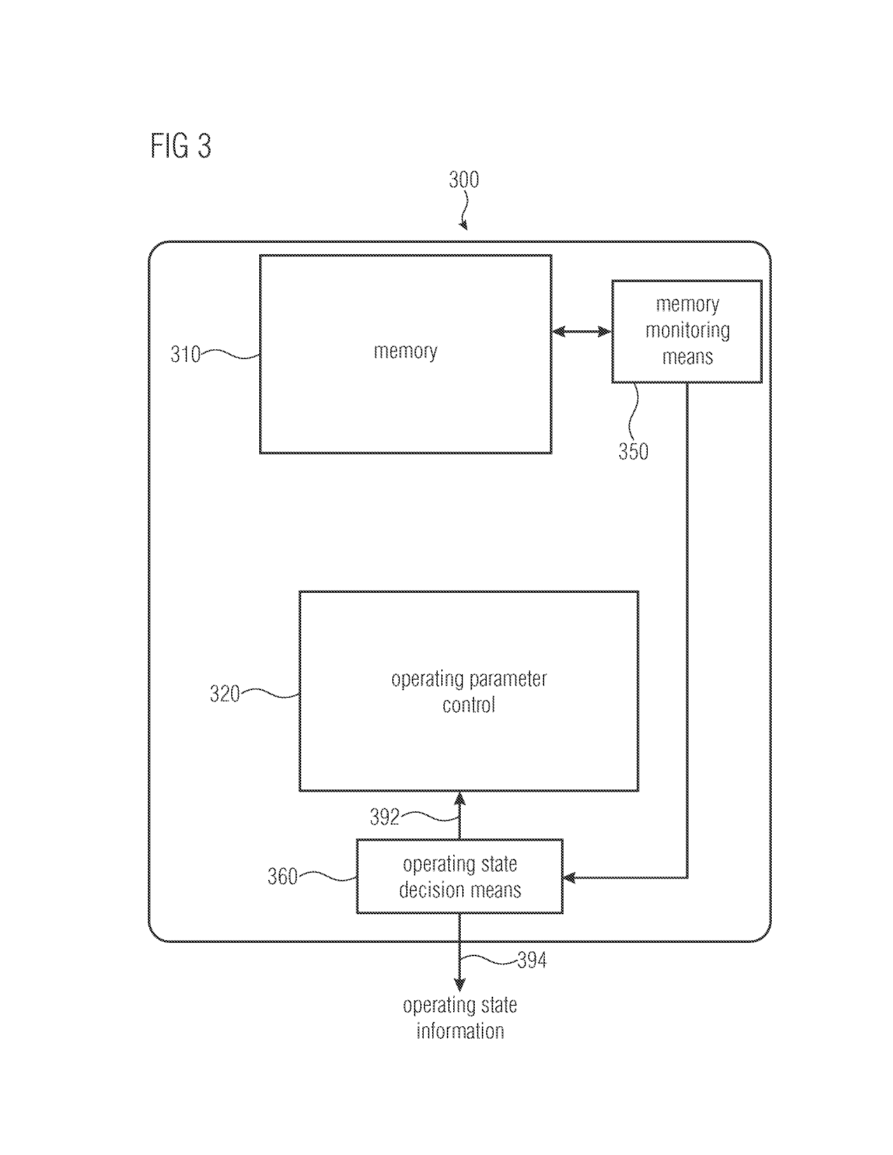

FIG. 3 shows a block diagram of a memory element according to a further embodiment of the invention. The memory element according to FIG. 3 is designated by 300 in its entirety. The memory element 300 includes a memory 310 which, for example, corresponds to the memory 210. The memory element 310 further includes an operating parameter control 320 which may, for example, correspond to the operating parameter control 220. Apart from that, the memory element 300 may include further components described with reference to FIG. 2, for example, a memory interface, a clock generator, a voltage regulator and/or a clock generator/voltage regulator interface. The operating parameter control 320 may further (optionally) include a time sequence control. Further, the operating parameter control 320 includes at least two operating parameter sets which are not illustrated in more detail.

The memory element 300 includes a memory monitoring means 350 which is implemented to monitor an activity of the memory 310. Further, the memory element 300 includes an operating state decision means 360 which is implemented to obtain information about an operating state or a capacity utilization of the memory 310 from the memory monitoring means 350. The operating state decision means 360 is further implemented to provide operating state information 392 to the operating parameter control 320. Further, the operating state decision means 360 may optionally provide operating state information or information derived from the same also as output information 394 at an external interface of the control module 300 (for example, for use by a memory controller or a processor).

The memory element 300 according to FIG. 3 is, for example, able to decide by itself whether a change of an operating state is to be performed. For this purpose, the memory monitoring means 350 monitors the operation of the memory 310 and determines, for example, how high the capacity utilization of the memory 310 is. Thus, the memory monitoring means 350 may determine, for example, how many accesses per time unit take place on the memory 310. According to the number of accesses per time unit, the memory monitoring means 350 determines information about a capacity utilization of the memory. Here, for example, peak values of capacity utilization may be determined over a certain period of time or an average value of capacity utilization may be used. Alternatively, the memory monitoring means 350 may use other features which provide information on memory capacity utilization.

Based on the capacity utilization information provided by the memory monitoring means 350, the operating state decision means 360 may decide in which operating state the memory 310 is to be operated. Thus, the operating state decision means 360 may, for example, decide that in the presence of a very low memory capacity utilization the memory 310 is to be operated in a standby state. With an average capacity utilization of the memory 310, the operating state decision means 360 may, for example, decide that the memory 310 is to be operated in a slow operating state (for example, with a comparatively low clock frequency and/or with a comparatively low operating voltage). If, however, a high capacity utilization (greater than a predetermined capacity utilization threshold value) of the memory 310 is given, the operating state decision means 360 may, for example, decide that the memory 310 is to be operated in a fast operating state (for example, with a comparatively high clock frequency and a comparatively high operating voltage). The operating state decision means may, for example, initiate a change between two operating states by the fact that it passes corresponding operating state information 392 to the operating parameter control 320 which then performs the transition between two states of operation.

The operating state decision means 360 may further communicate changes of the operating state via an external interface of the memory element 300 to a memory controller and/or a processor, wherein the memory controller and/or the processor may adapt to the change of the operating state of the memory 310. For example, components, for example, the memory controller and/or processor (which are not part of the memory element), may be implemented in order to set an accessing speed to the memory element 300, depending on the information 394. Further, for example, the memory controller and/or the processor may be implemented to set further interface parameters (for example, interface level, an interface clock frequency, an interface termination state or a refresh rate, using which the memory 310 is refreshed), depending on the information 394 from the operating state decision means 360.

Thus, in one embodiment of the invention, the memory element 300 and not an external memory controller or an external processor decides on the operating state of the memory. This functionality is advantageous as the memory element 300 may typically see best which operating state is suitable. Thus, it is basically relevant for the operating state of the memory element 300 which capacity utilization is given with regard to the memory itself, but not which capacity utilization, for example of the processor, is given. If, for example, the processor shows a high capacity utilization, but only accesses other memory elements from a plurality of memory elements, the corresponding memory element which is hardly accessed, or not at all, may still pass into a slow, energy-saving operating state without the system power being affected substantially. It may be seen from the illustrated examples that the capacity utilization of the memory element 300 itself is a well-suited criterion to decide in which operating state the memory element is to be operated.

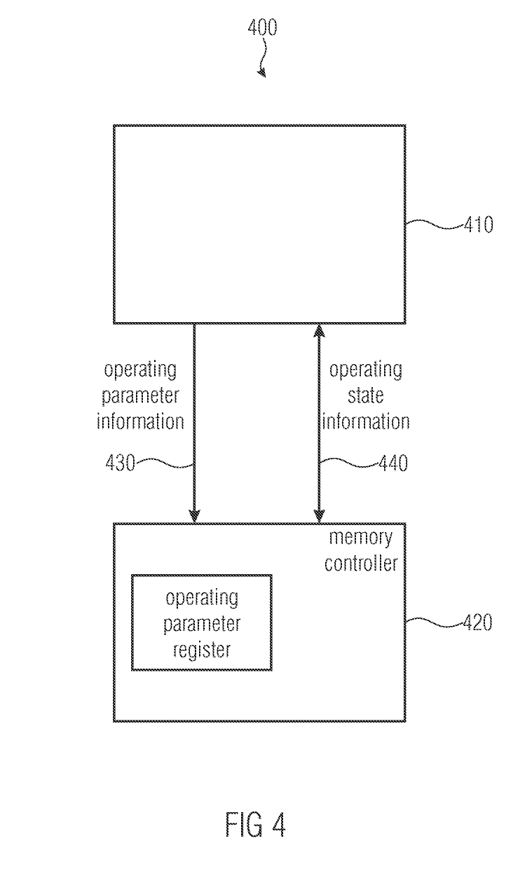

FIG. 4 shows a block diagram of a data processing system according to one embodiment of the invention. The data processing system according to FIG. 4 is designated by 400 in its entirety. The data processing system 400 includes a memory element 410 which may, for example, be the memory element 100 according to FIG. 1, the memory element 200 according to FIG. 2 or the memory element 300 according to FIG. 3. In one embodiment, the memory element 410 is a memory module. In other words, a memory 110 and an associated operating parameter control 120 are, for example, integrated in a memory module. In a further embodiment, the memory element 410 is an integrated circuit, so that the memory and the associated operating parameter control are monolithically integrated.

The data processing system 400 further includes a memory controller 420 which is, for example, a chip which is separate from the memory element 410. The memory controller 420 may, for example, be a specialized chip which, as a separate chip, provides a connection between a processor and the memory element 410. The memory controller 420 may, however, in an alternative embodiment, also be part of a processor.

In one embodiment of the invention, the memory controller 420 may, for example, be implemented to read out operating parameter information from the memory element 410. In this respect, the memory element 410 is, for example, able to output at least a part of the operating parameters of the operating parameter sets, for example in an encoded form via an interface to the memory controller. Further, the memory element 410 may alternatively or additionally be able to output information to the memory controller 420 which indicates which operating states are possible and/or allowable. For example, the memory element 410 may be implemented to inform in the memory controller via a corresponding interface that a standby state, a slow operating state and a fast operating state are available. The corresponding operating states may, for example, be encoded according to a predefined standard. Alternatively or additionally, the memory element 410 may be able to indicate individual operating parameters in different operating states to a memory controller, so that the same may, for example, be adapted to the operating state of the memory element. For example, the memory element may inform the memory controller 420 that in a fast operating state a clock frequency of 400 MHz is to be used, while in a slow operating state a clock frequency of 150 MHz is to be used. Thus, the memory controller 420 may obtain a description of parameters in the different operating states from the memory element 410 and accordingly adapt a data exchange with the memory element.

In one embodiment, the memory controller may further be implemented to supply operating state information 440 to the memory element 410. If the memory controller 420 thus determines that an operating state of the memory element 410 is to be changed (for example, because an especially high or an especially low capacity utilization is present, or if the necessity exists to deal with the available energy especially economically), the memory controller 420, for example, passes the corresponding operating state information to the memory element 410. The memory controller 420 thus communicates abstract information to the memory element 410 which describes an operating state detached from actual technical operating parameter values. Thus, the memory controller 420, for example, informs the memory element 410 that the memory element 410 should pass into a standby state, into a slow operating state or into a fast operating state. The operating parameter control (for example the operating parameter control 120) of the memory element 400 thereupon translates this abstract description of an operating state into a set of operating parameter values, by the operating parameter control, for example selecting an operating parameter set based on the operating state information. Here, the operating parameter control may, for example, use a lookup table. Thus, the operating parameter control determines a concrete set of operating parameter values (for example: clock frequency=400 MHz; operating voltage=1.8 V) from the abstract operating state information (for example, standby, fast, slow), which is used for setting the operating parameters of the memory.

Thus, setting the actual operating parameter values may take place independently by the memory element itself without the memory controller 420 determining the concrete operating parameter values. Thus, the memory controller 420 is offloaded from details with regard to the memory.

In a further embodiment, the memory element 410 itself causes the determination of the operating state. A corresponding memory element was described with reference to FIG. 3. In this case, not the memory controller 420 initiates the change of an operating state, but the memory element 410 (which is then, for example, a memory element 300). The operating state decision means of the memory element decides, with a corresponding change of the capacity utilization of the memory element, that a change of the operating state has to take place. Thus, the memory element 410 informs the memory controller 420 of an upcoming change of the operating state, so that the memory controller 420 may adapt to a change of the operating state (for example, using the operating parameter information 430 read out by the memory element 410). Thus, for example, the memory controller may adapt the clock frequency and/or other interface parameters of a memory controller-to-memory interface according to the read-out operating parameter information 430 and in response to the transmission of operating state information 440.

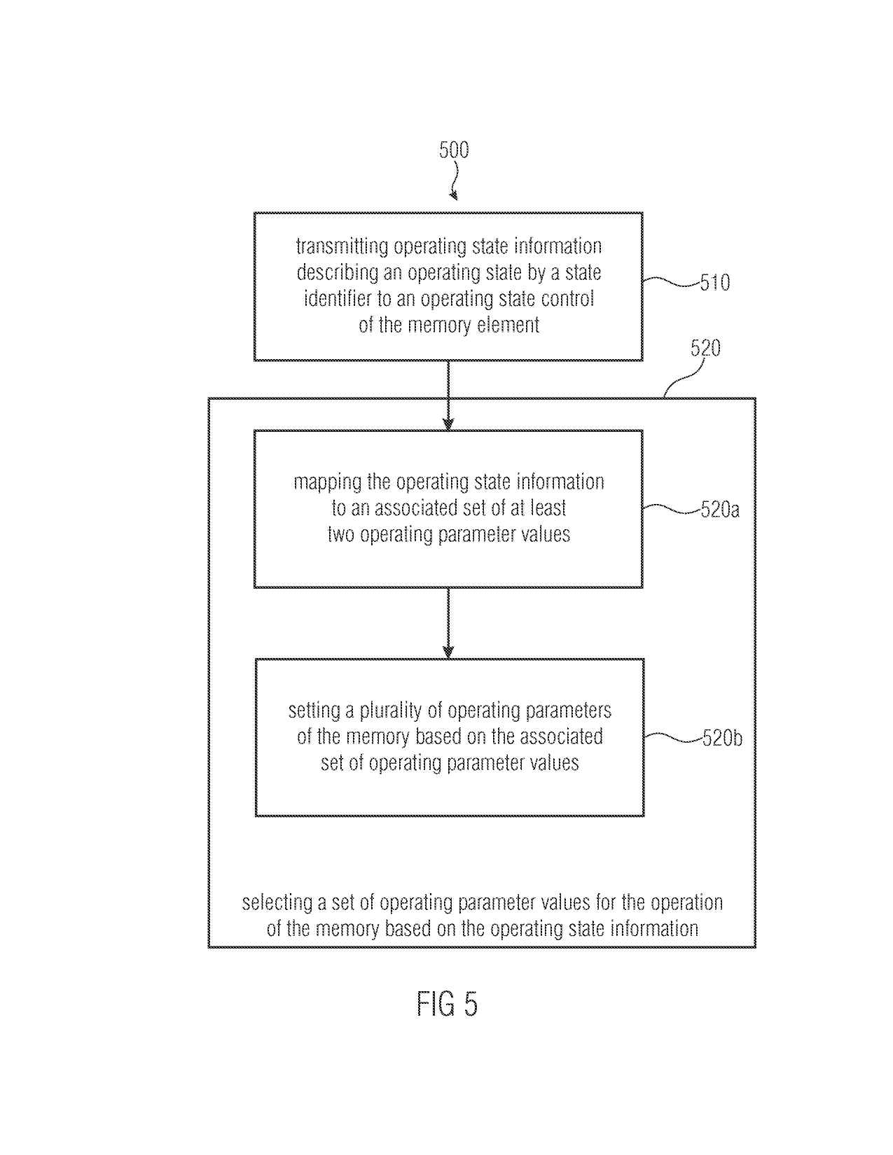

FIG. 5 shows a flowchart of a method for setting operating parameters of a memory (for example the memory 110) in a memory element (for example, in the memory element 100). The method according to FIG. 5 is designated by 500 in its entirety. With regard to the method 500 it is assumed that the memory is operable according to operating parameters from at least two sets of operating parameters. The method 500 according to FIG. 5 includes in a first step 510 a transmission of operating state information which describes an operating state by a state identifier to an operating state controller of the memory element. In a second step 520 the method 500 further includes selecting a set of operating parameter values for the operation of the memory based on the operating state information.

The method 500 according to FIG. 5 may, apart from that, be extended by all those steps and/or features which are illustrated within the context of the present description. In one embodiment, for example, selecting a set of operating parameter values for the operation of the memory may include mapping 520a the operating state information to an associated set of at least two operating parameter values and setting 520b a plurality of operating parameters of the memory based on the associated set of operating parameter values.

The inventive devices and the inventive methods may be implemented in hardware or in software. The implementation may be on a digital storage medium, for example, a floppy disc, a CD, a DVD, an ROM, a PROM, an EPROM, an EEPROM or a FLASH memory having electronically readable control signals which may cooperate with a programmable computer system so that the corresponding method is performed. In general, the invention thus also consists in a computer program product having a program code stored on a machine-readable carrier for performing the inventive method when the computer program product runs on a computer. In other words, the invention may be realized as a computer program having a program code for performing the inventive method, when the computer program runs on a computer.

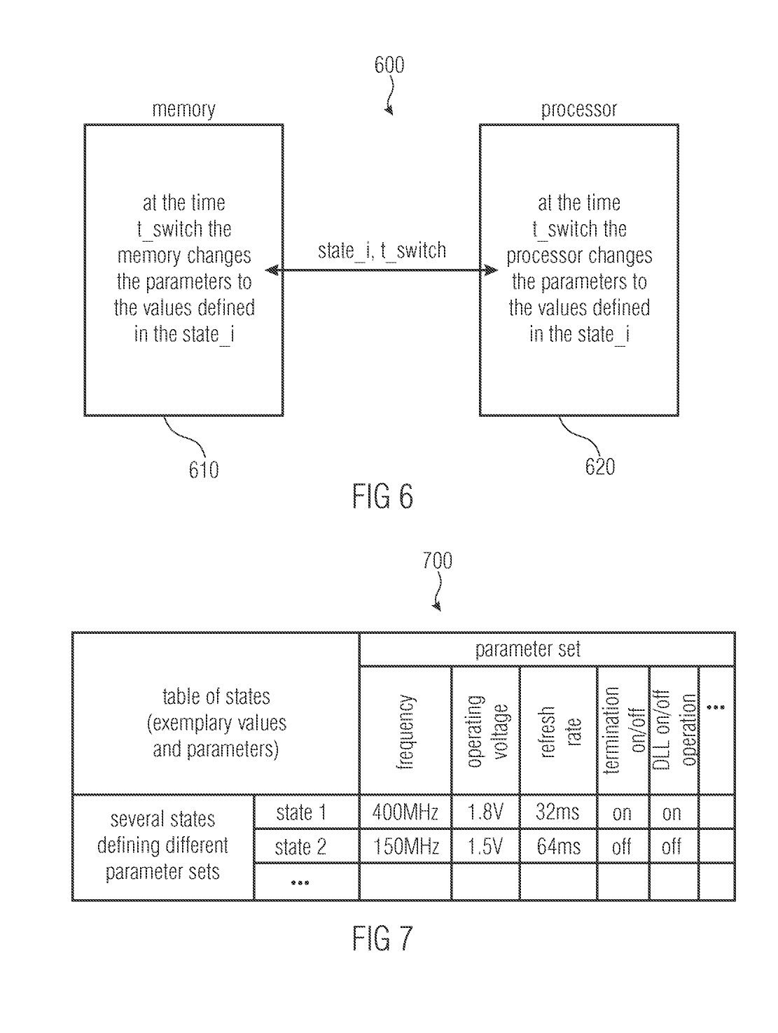

FIG. 6 shows a schematical illustration of the cooperation between a memory 610 and a processor 620 according to one embodiment of the invention. The schematical illustration according to FIG. 6 is designated by 600 in its entirety. The schematical illustration 600 includes a memory 610 and a processor 620. The processor 620 may alternatively also be replaced by a memory controller.

Between the memory 610 and the processor 620 an exchange of information takes place, wherein operating state information (state_i) and (optionally) time information (t_switch) are exchanged. The operating state information (state_i) here shows which operating state is to be taken on next. The optional time information t_switch further indicates at which point in time a change of state is to take place.

In this respect it is to be noted that the data exchange may, for example, be initiated by the processor 620 which instructs the memory to perform a change of state. Alternatively, the data exchange may, however, also be initiated by the memory 610, which in this case informs the processor that the memory 610 will perform a change of state. Following the data exchange of the operating state information state_i and the optional time information t_switch, the memory 610 changes parameters and/or operating parameters to values which are defined in the new state state_i at the time t_switch. In a similar way, the processor changes parameters and/or operating parameters to values which are defined in the new state state_i at the time t_switch. Thus, both the memory 610 and also the processor 620 change their operating parameters at the time t_switch.

If, apart from that, no time information t_switch is transmitted, according to the convention, for example, the change of states may take place a predetermined delay time after performing the data communication.

It is further to be noted that the change of state does not have to take place instantaneously, but may take a certain period of time. Thus, for example, beginning at the switching time t_switch (or beginning already a certain time before the switching time) a time interval may exist, during which an exchange of useful information is not possible between the memory 610 and the processor 620.

The operating parameters which are changed may, for example, be an operating voltage of the memory, a clock frequency of the memory, interface parameters of an interface between the memory and the processor (for example, latency, signal level, termination state) or a refresh rate.

FIG. 7 shows a tabular illustration of different states according to one embodiment of the invention. The tabular illustration according to FIG. 7 is designated by 700 in its entirety. The tabular illustration 700 thus forms a table of states which shows exemplary values and parameters for different states. Here, several states define different parameter sets. In other words, one parameter set is associated with each state. A parameter set, for example, includes one or several of the following parameters: frequency, operating voltage, refresh rate, termination on/off, DLL operation on/off. A parameter set may, however, also include other and/or additional parameters. In a first state illustrated exemplarily, a frequency (for example, a clock frequency of the memory) is 400 MHz. An operating voltage (for example, an operating voltage of the memory) is 1.8 V. A refresh rate is 32 ms. In the first state, for example, the termination (for example, of lines of a memory interface) is switched on (wherein the termination may, for example, be within the memory element). In the first state, for example, further a delay-locked loop is switched on. In a second operating state (state 2), for example, the frequency is 150 MHz and the operating voltage is 1.5 V. The refresh rate in the second state is, for example, 64 ms. Further, in the second operating state the termination is, for example, switched off, as is the delay-locked loop (DLL). It is to be noted that, for example, the first state is a fast operating state, while the second state, however, is a slow operating state. Of course, in other embodiments, further states may exist, wherein a parameter set is, for example, associated with each operating state.

With reference to FIGS. 6 and 7 it is thus illustrated again how a selection of an operating state and/or an operating status may take place, wherein parameter sets are used which are assigned to the individual operating states.

In summary, it is thus to be noted that according to one embodiment of the present invention the described concept and/or the described method eliminate the different performance of different memory types. Thus, in one embodiment the inventive concept and/or method enable simultaneously changing several parameters of the memory (and/or the memory element) and the memory-graphics processor interface (memory GPU interface). This is, for example, achieved by using predefined parameter sets (“states”), which are known both to the controller and also to the memory. A graphics processor (generally: a processor or a memory controller) and/or the memory may select a state and communicate this together with information when the change will take place. Thereupon, both the controller and also the memory may individually and/or separately change the parameters according to the selected set of parameters at the defined time.

The different parameter sets (i.e., for example, the different sets of operating parameters) may be defined and communicated beforehand (i.e., for example, within the context of an initialization, for example, before a transition into a normal operating state). This may, for example, take place dynamically, for example, during a system initialization (system boot). Alternatively, the parameter sets may also be defined statically, for example, by a standardization.

It would further be possible to change the parameter sets dynamically (for example, during the operation of the memory element). For example, during an operation a selection might take place as to which parameter sets of a predetermined amount of parameter sets are to be used. Thus, the memory element may be programmable in this respect. Alternatively or additionally, it would, for example, be possible to dynamically create a new parameter set during an operation of the memory element.

Alternatively, it is possible that the parameter sets are unchangeable during an operation of the memory element. In other words, in some embodiments, during an operation of the memory element, only statically stored data sets are used.

Some embodiments of the invention thus provide the advantage that a configuration of little effort, wherein the procedure in the configuration is basically independent of the used memory type.

It is further to be noted that embodiments of the invention may, for example, be used in different systems which include a controller and a memory which are connected to each other.

The above-described operating parameter control may, for example, be monolithically integrated with the above-described memory. The memory element may thus, for example, be a memory chip.

The operating parameter control may, however, alternatively be arranged externally, i.e., for example, on another chip than the memory. For example, the operating parameter control may be realized in a memory controller which is coupled to the memory.

Alternatively, for example, the operating parameter control and the memory may be arranged on a memory module. For example, the operating parameter control and the memory may be arranged in two separate chips on the memory module. Alternatively, the operating parameter control and the memory may, however, also be arranged on a chip of the memory module.

A memory element may, for example, be a memory chip which includes the memory and the operating parameter control. A memory element may, however, also be a memory module. Further, a memory element may, for example, be a part of an overall system which serves for storing data and which is, for example, connected to the overall system in a detachable or non-detachable way.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

What is claimed is:

1. A memory element, comprising:
a memory which is operable according to operating parameters from at least two sets of operating parameter values; and
an operating parameter control which is implemented to receive operating state information to select a set of operating parameter values for the operation of the memory based on the operating state information and to set a plurality of operating parameters of the memory based on the selected set of operating parameter values.

2. The memory element according to claim 1, wherein the operating parameter control is implemented to map the operating state information to an associated set of at least two operating parameter values, and to set a plurality of operating parameters of the memory based on the associated set of operating parameter values.

3. The memory element according to claim 1, wherein the operating parameter control is implemented to receive value discrete information as operating state information, to identify a certain state from a predetermined, countable overall amount of states based on the operating state information, and to map the determined state to an associated set of at least two operating parameter values.

4. The memory element according to claim 1, wherein the operating parameter control is implemented to map the operating state information to the sets of operating parameter values, so that a product amount, which is formed of amounts of actually occurring operating parameter values, for describing all possible combinations of operating parameter values, comprises more elements than operating states that are describable by the operating state information.

5. The memory element according to claim 1, wherein an integration of the memory and the operating parameter control is selected from a group comprising an integration of the memory and the operating parameter control on a memory module and a monolithic integration of the memory and the operating parameter control.

6. The memory element according to claim 1, wherein the operating parameter control is implemented to receive time information, and to determine a time when a change from a previous operating state to a new operating state takes place by the selection of a new set of operating parameter values, depending on the time information.

7. The memory element according to claim 1, wherein the operating parameter control comprises a sequence control which is implemented to determine a time sequence of changes of operating parameters in a change from a previous operating state to a new operating state.

8. The memory element according to claim 7, wherein the sequence control is implemented to change an operating parameter in a plurality of steps in a change from a previous operating state into a new operating state.

9. The memory element according to claim 7, wherein the sequence control is implemented to at first change a first operating parameter of the memory and subsequently change a second operating parameter of the memory in a change from a previous operating state into a new operating state.

10. The memory element according to claim 1, wherein the operating parameter control comprises a lookup table and is implemented to select an entry of the lookup table based on the operating state information, wherein the selected entry of the lookup table comprises the set of operating parameter values.

11. The memory element according to claim 1, wherein the memory element comprises a monitoring circuit, which is implemented to provide the operating state information and transmit the same to the operating parameter control,
wherein the monitoring circuit is implemented to determine a capacity utilization of the memory and to change the operating state information depending on the capacity utilization of the memory.

12. The memory element according to claim 11, wherein the memory element comprises an interface, which is implemented to output the operating state information provided by the monitoring circuit.

13. The memory element according to claim 1, wherein the operating parameters are selected from a group, comprising:
an operating voltage of the memory, wherein the memory element comprises a settable voltage regulator, which is implemented to regulate an operating voltage for the memory and which is coupled to the operating parameter control such that the voltage provided by the voltage regulator is dependent on which set of operating parameter values is selected;
a clock frequency of the memory, wherein the memory element comprises a settable clock frequency generator which is implemented to provide a clock signal for the memory and which is further coupled to the operating parameter control such that a frequency of the clock signal provided by the settable clock frequency generator depends on which set of operating parameter values is selected;
an operating voltage of the memory, wherein the memory element comprises an interface for controlling an externally settable voltage regulator, which is implemented to provide a control signal for the external voltage regulator depending on which set of operating parameter values is selected;
a clock frequency of the memory, wherein the memory element comprises an interface for controlling an externally settable clock frequency generator, which is implemented to provide a control signal for the external clock frequency generator depending on which set of operating parameter values is selected;
a refresh rate of the memory;
a terminating state of interface lines of the memory; and
an operating state of a delay-locked loop, which is connected between interface lines and associated terminals of the memory.

14. The memory element according to claim 1, wherein the memory element comprises an interface, which is implemented to output information on selectable sets of operating parameter values to a processor or a memory controller.

15. A memory element, comprising:
a means for storing information operable according to operating parameters from at least two sets of operating parameter values; and
a means for selecting a set of operating parameter values for the operation of the means for storing information based on received operating state information.

16. A data processing system, comprising:
a memory element, comprising:
a memory which is operable according to operating parameters from at least two sets of operating parameter values;
an operating parameter control which is implemented to receive operating state information to select a set of operating parameter values for the operation of the memory based on the operating state information and to set a plurality of operating parameters of the memory based on the selected set of operating parameter values; and
a memory controller, which is coupled to the memory element.

17. The data processing system according to claim 16, wherein the memory controller is implemented to output operating state information to the memory element within the context of changing the operating state,
wherein the memory element is implemented to change at least two operating parameters of the memory under its own control as a reaction to the operating state information output from the memory controller, and
wherein the memory controller is further implemented to change data exchange parameters for a data exchange with the memory element within the context of changing the operating state in order to acquire a utilization capacity-dependent setting of the data exchange parameters.

18. The data processing system according to claim 16, wherein the memory controller is implemented to read in and to store information about selectable sets of operating parameter values of the memory element from the memory element and, within the context of changing the operating state based on the stored information on selectable sets of operating parameter values of the memory element, to generate operating state information identifying a selectable set of operating parameter values and send the same to the memory element.

19. The data processing system according to claim 16, wherein the memory controller is implemented to receive operating state information provided by a monitoring circuit of the memory element and to change data exchange parameters for a data exchange with the memory element depending on the operating state information.

20. A method for setting operating parameters of a memory in a memory element, wherein the memory is operable according to the operating parameters from at least two sets of operating parameter values, the method comprising:
transmitting operating state information describing an operating state by a state identifier to an operating state control of the memory element; and
selecting a set of operating parameter values for the operation of the memory based on the transmitted operating state information.

21. The method according to claim 20, wherein selecting a set of operating parameter values comprises mapping the state identifier to an associated set of at least two operating parameter values and setting a plurality of operating parameters of the memory based on the associated set of operating parameter values.

22. The method according to claim 20, further comprising transmitting time information to the operating parameter control and determining a time when a change from a previous operating state into a new operating state takes place by the selection of a new set of operating parameter values depending on the time information.

23. The method according to claim 20, wherein a direct change of the operating state information from a first operating state into a second operating state causes a stepwise change of an operating parameter in several individual steps.

24. The method according to claim 20, wherein a direct change of the operating state information from a first operating state into a second operating state causes a change of a first operating parameter of the memory and subsequently a change of a second operating parameter of the memory.

25. A computer program for performing, when the computer program runs on a computer, a method for setting operating parameters of a memory in a memory element, wherein the memory is operable according to the operating parameters from at least two sets of operating parameter values, the method comprising:
transmitting operating state information describing an operating state by a state identifier to an operating state control of the memory element; and
selecting a set of operating parameter values for the operation of the memory based on the transmitted operating state information.
